(19) United States
(12) Patent Application Publication
(10) Pub. No.: US 2026/0175778 A1
(43) Pub. Date: Jun. 25, 2026

(54) OFF-ROAD VEHICLE DOOR REAR-VIEW MIRROR MOUNTING BRACKET

(71) Applicant: GUANGZHOU ISSYZONE TECHNOLOGY CO., LIMITED, Guangzhou (CN)

(72) Inventors: Zhuo Jia, Guangzhou (CN); Taiping Yang, Guangzhou (CN); Guoyuan Lin, Guangzhou (CN)

(21) Appl. No.: 19/399,142

(22) Filed: Nov. 24, 2025

(30) Foreign Application Priority Data
Dec. 23, 2024 (CN) 202423177445.5

(51) Int. Cl. B60R 1/02

(52) U.S. Cl. CPC B60R 1/025

(57) ABSTRACT

Disclosed is an off-road vehicle door rear-view mirror mounting bracket, including a fixed bracket configured to connect to a vehicle door, where the fixed bracket is provided with a first movable bracket rotatable about an X-axis with damping, the first movable bracket is provided with a second movable bracket rotatable about a Z-axis with damping, the second movable bracket is provided with a locking member configured to lock a rear-view mirror, and the rear-view mirror remains connected to the second movable bracket and is rotatable about a Y-axis when the locking member is released from locking. The present disclosure may facilitate flexible adjustment of the mounting position of the rear-view mirror, avoid blind spots, and thus adapt to different off-road driving conditions.

### CROSS REFERENCE TO RELATED APPLICATIONS

The present disclosure claims the priority of Chinese Patent Application No. 2024231774455 filed on Dec. 23, 2024 before CNIPA. All the above are hereby incorporated by reference in their entirety.

### TECHNICAL FIELD

The present disclosure relates to the technical field of off-road vehicle door rear-view mirror mounting components, and in particular, to an off-road vehicle door rear-view mirror mounting bracket.

### BACKGROUND

Off-road vehicles have superior off-road performance and are capable of driving in complex road conditions, thereby satisfying people's demand for off-road self-driving adventures. Due to the complex and variable off-road conditions, for driving safety, drivers need to adjust the mounting position of the off-road vehicle door rear-view mirror according to the actual off-road conditions to obtain a suitable observation field of view. However, the originally installed off-road vehicle door rear-view mirror may only be adjusted by rotating back and forth, making it difficult to adapt to the complex and variable off-road conditions, easily causing blind spots and affecting off-road driving safety.

### SUMMARY

An objective of the present disclosure is to provide an off-road vehicle door rear-view mirror mounting bracket, which may flexibly adjust the mounting position of the rear-view mirror, avoid blind spots, and thus adapt to different off-road driving conditions.

The objective of the present disclosure is achieved by the following technical solutions:

An off-road vehicle door rear-view mirror mounting bracket includes a fixed bracket configured to connect to a vehicle door. The fixed bracket is provided with a first movable bracket rotatable about an X-axis, the first movable bracket is provided with a second movable bracket rotatable about a Z-axis, the second movable bracket is provided with a locking member configured to lock a rear-view mirror, and the rear-view mirror remains connected to the second movable bracket and is rotatable about a Y-axis when the locking member is released from locking.

Based on the above technical solutions, the present disclosure may be improved as follows:

In some implementations, the fixed bracket is formed with a door connection portion configured to connect to the vehicle door, and a first connection portion located on a side of the fixed bracket away from the door connection portion, and the first movable bracket is rotatably connected to the first connection portion about the X-axis.

In some implementations, the fixed bracket is provided with a connection column parallel to the X-axis at the first connection portion, the first movable bracket is rotatably connected to the connection column via a first damping member, and the connection column causes a gap to be formed between the first movable bracket and the fixed bracket.

In some implementations, the connection column is formed with a first cooperation chamber at an end away from the fixed bracket, the first movable bracket is rotatably connected to a connection end of the connection column, and causes the first damping member to be in rotational cooperation with the first cooperation chamber.

In some implementations, the first movable bracket is formed with a second connection portion rotatably connected to the connection column, and a third connection portion located on a side of the first movable bracket away from the second connection portion, and the second movable bracket is rotatably connected to the third connection portion about the Z-axis.

In some implementations, the first movable bracket is provided with a connection block movable along the X-axis, an end of the connection block extends out of the first movable bracket parallel to the fixed bracket, an extension end of the connection block serves as the third connection portion, and the second movable bracket is rotatably connected to the extension end of the connection block via a second damping member.

In some implementations, a bottom surface of the connection block is provided with a guide block, the first movable bracket is provided with a guide groove parallel to the X-axis, the guide block is slidably connected to the guide groove and slides along the guide groove; the first movable bracket is provided with an elongated hole communicating with the guide groove at a bottom portion, and a bolt passes through the elongated hole into the guide groove to lock the guide block.

In some implementations, a length of the guide block is greater than a length of the guide groove.

In some implementations, a side of the second movable bracket is provided with a fourth connection portion, the second movable bracket is provided with a second cooperation chamber at the fourth connection portion, the fourth connection portion is rotatably connected to the extension end of the connection block, and causes the second damping member to be in rotational cooperation with the second cooperation chamber.

In some implementations, the second movable bracket is provided with a mounting surface capable of fitting with a back surface of the rear-view mirror, the second movable bracket is provided with a locking groove with an axis parallel to a Y-axis on a back surface, a bottom of the locking groove is provided with a through hole communicating with the mounting surface of the second movable bracket, and the locking member passes through the locking groove and the through hole in sequence to lock the rear-view mirror.

Compared to the prior art, the present disclosure provides beneficial effects as follows.

According to the present disclosure, by providing the first movable bracket on the fixed bracket, the first movable bracket being rotatable about the X-axis with damping, the first movable bracket being provided with the second movable bracket, the second movable bracket being rotatable about the Z-axis with damping, the second movable bracket being provided with a locking member, the rear-view mirror being mounted on the second movable bracket and locked by the locking member, and the rear-view mirror remaining connected to the second movable bracket and being rotatable about the Y-axis when the locking member is released from locking, it facilitates flexible adjustment of the mounting position of the rear-view mirror, and a suitable field of view may be obtained in complex and variable off-road conditions, blind spots may be avoided, and off-road driving safety may be improved.

### BRIEF DESCRIPTION OF THE DRAWINGS

The present disclosure is further described below in conjunction with the drawings and specific embodiments.

FIG. 1 is a schematic structural diagram of the off-road vehicle door rear-view mirror mounting bracket in the embodiment.

FIG. 2 is an exploded view of the off-road vehicle door rear-view mirror mounting bracket in the embodiment.

FIG. 3 is a schematic bottom view of the off-road vehicle door rear-view mirror mounting bracket in the embodiment.

FIG. 4 is a schematic diagram of the off-road vehicle door rear-view mirror mounting bracket adjusting the mounting position of the rear-view mirror by translating along the X-axis direction in the embodiment.

The reference numerals in the drawings are: 1 fixed plate; 1a door connection portion; 1b first connection portion; 2 locking hole; 3 connection column; 4 first damping member; 5 connection seat; 5a first straight section; 5b second straight section; 5c second connection portion; 5d third connection portion; 6 first limiting groove; 7 connection block; 8 second damping member; 9 second limiting groove; 10 guide block; 11 guide groove; 12 elongated hole; 13 support plate; 13a fourth connection portion; 14 locking groove.

### DETAILED DESCRIPTION

The specific embodiments of the present disclosure are further described below with reference to the accompanying drawings. The description of these embodiments is intended to help understand the present disclosure but does not limit the present disclosure. Furthermore, the technical features involved in the various embodiments of the present disclosure described below may be combined with each other as long as they do not conflict with each other.

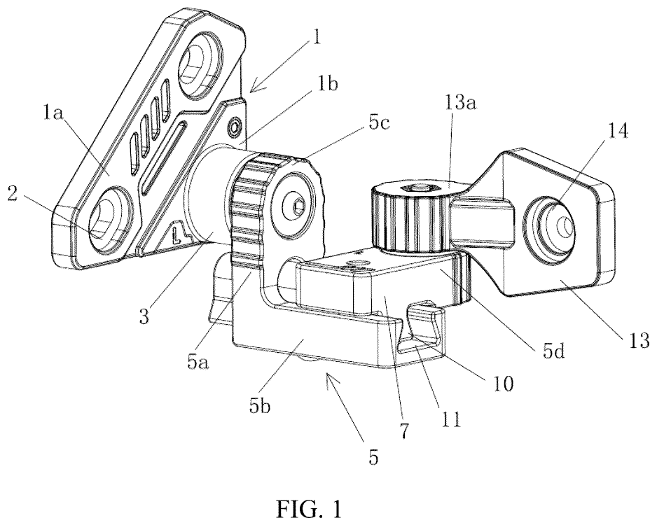

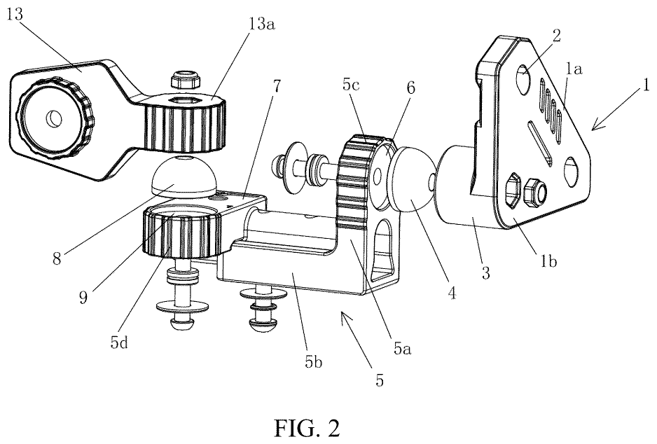

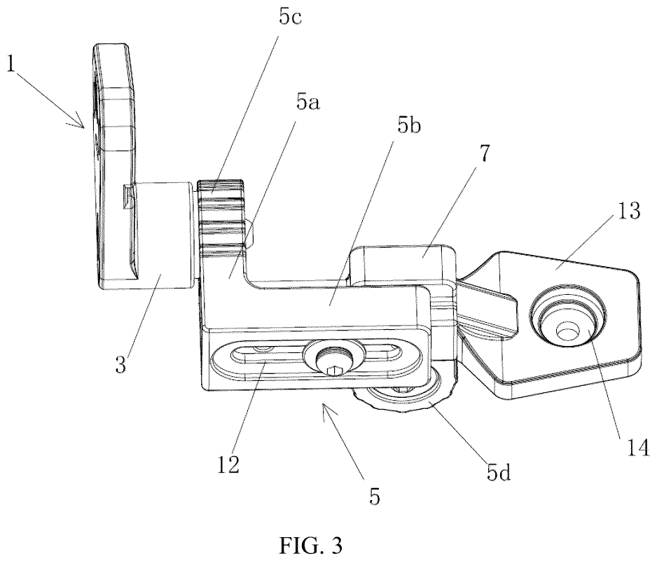

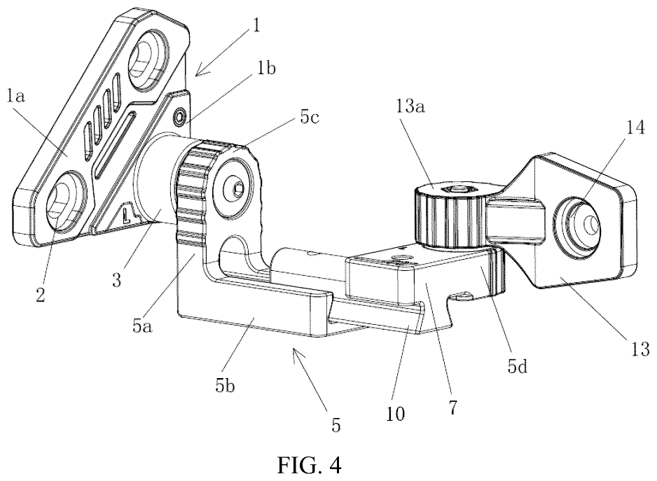

Referring to FIGS. 1 to 4, the present embodiment relates to an off-road vehicle door rear-view mirror mounting bracket, including a fixed bracket fixedly connected to a vehicle door, a first movable bracket provided on the fixed bracket and rotatable about an X-axis, and a second movable bracket provided on the first movable bracket and rotatable about a Z-axis, where the second movable bracket is configured to connect to a rear-view mirror, so that the rear-view mirror is rotatable about a Y-axis and fixed by a locking member; through the first movable bracket and the second movable bracket, the mounting position of the rear-view mirror may be flexibly adjusted, and a suitable field of view may be obtained in complex and variable off-road conditions, blind spots may be avoided, and off-road driving safety may be improved.

Specifically, the fixed bracket is a fixed plate 1, the fixed plate 1 is provided with a door connection portion 1a and a first connection portion 1b, the door connection portion 1a is fixedly connected to the vehicle door by bolts, and the door connection portion 1a is provided with locking holes 2 for bolts to pass through; the first connection portion 1b is located on a side of the fixed plate 1 away from the door connection portion 1a, and is rotatably connected to the first movable bracket about the X-axis; in the present embodiment, the fixed bracket adopts the fixed plate 1, and according to actual needs, other structures of fixed brackets may be employed instead.

In the present embodiment, the fixed plate 1 has a right-angled triangular plate structure, and a region between two acute angles of the fixed plate 1 serves as the door connection portion 1a; two locking holes 2 are provided, the two locking holes 2 are respectively located at the two acute angles of the fixed plate 1 and are both elongated holes, to facilitate locking of bolts and fine adjustment of the position of the fixed plate 1; a right-angled corner of the fixed plate 1 serves as the first connection portion 1b and is provided with a connection column 3, an axis of the connection column 3 is perpendicular to a plate surface of the fixed plate 1 and parallel to the X-axis, the first movable bracket is rotatably connected to the connection column 3 via a first damping member 4, and rotates about the axis of the connection column 3; the connection column 3 enables a gap to be formed between the first movable bracket and the fixed plate 1, preventing contact between the first movable bracket and the plate surface of the fixed plate 1 to avoid friction, and ensuring smooth rotation of the first movable bracket.

The connection column 3 has a cylindrical structure, an end of the connection column 3 away from the fixed plate 1 is a connection end and forms a first cooperation chamber capable of cooperating with the first damping member 4, the first movable bracket is rotatably connected to the connection end of the connection column 3, and causes the first damping member 4 to be in damping rotational cooperation with the first cooperation chamber in the connection column 3; the first damping member 4 may generate a damping force in the first cooperation chamber when the first movable bracket rotates about the X-axis on the fixed plate 1, so as to maintain a fixed state after adjusting the mounting position of the rear-view mirror by rotating about the X-axis.

The first movable bracket is a connection seat 5, the connection seat 5 has a second connection portion 5c and a third connection portion 5d, the second connection portion 5c is rotatably connected to the connection end of the connection column 3; the third connection portion 5d is located on a side of the connection seat 5 away from the second connection portion 5c, and is rotatably connected to the second movable bracket about the Z-axis; in the present embodiment, the first movable bracket adopts the connection seat 5, and according to actual needs, other structures of movable brackets may be employed instead.

In the present embodiment, the connection seat 5 has an L-shaped seat structure in cross-section, the connection seat 5 has a first straight section 5a and a second straight section 5b; the first straight section 5a of the connection seat 5 is parallel to the fixed plate 1, an end of the first straight section 5a is perpendicularly connected to an end of the second straight section 5b, an opposite end of the first straight section 5a serves as the second connection portion 5c and is rotatably connected to the connection end of the connection column 3, the first straight section 5a is provided with a first limiting groove 6 on a side adjacent to the connection end of the connection column 3, the first limiting groove 6 is configured to limit and install the first damping member 4 at the second connection portion 5c of the connection seat 5, so that the first damping member 4 may be in damping rotational cooperation with the first cooperation chamber in the connection column 3.

The second straight section 5b of the connection seat 5 is provided with a connection block 7, an end of the connection block 7 extends out of the second straight section 5b of the connection seat 5 parallel to the fixed plate 1, the extension end of the connection block 7 serves as the third connection portion 5d, the second movable bracket is rotatably connected to the extension end of the connection block 7 via a second damping member 8 and rotates about the Z-axis, the second movable bracket has a second cooperation chamber capable of cooperating with the second damping member 8; the connection block 7 enables a gap to be formed between the second movable bracket and the second straight section 5b of the connection seat 5, preventing contact between the second movable bracket and the surface of the second straight section 5b of the connection seat 5 to avoid friction, and ensuring smooth rotation of the second movable bracket.

The connection block 7 has a rectangular block structure. An end of the connection block 7 is connected to the second straight section 5b of the connection seat 5. An opposite end of the connection block 7 is an extension end and extends out of the second straight section 5b of the connection seat 5 parallel to the fixed plate 1. The extension end of the connection block 7 is provided with a second limiting groove 9. The second limiting groove 9 is configured to limit and install the second damping member 8 at the second connection portion 5c of the connection seat 5, so that the second damping member 8 may be in damping rotational cooperation with the second cooperation chamber on the second movable bracket. The second damping member 8 may generate a damping force in the second cooperation chamber when the second movable bracket rotates about the Z-axis on the connection block 7, so as to maintain a fixed state after adjusting the mounting position of the rear-view mirror by rotating about the Z-axis.

In some embodiments, in the present embodiment, the connection block 7 is movably connected to the second straight section 5b of the connection seat 5, so that the connection block 7 may translate along the X-axis direction on the second straight section 5b of the connection seat 5 to adjust the mounting position of the rear-view mirror.

A bottom surface of the connection block 7 is provided with a guide block 10. A top portion of the second straight section 5b of the connection seat 5 is provided with a guide groove 11 parallel to the X-axis direction. The guide block 10 is slidably connected to the guide groove 11 and slides along the guide groove 11. A bottom portion of the second straight section 5b of the connection seat 5 is provided with an elongated hole 12 communicating with the guide groove 11. A bolt passes through the elongated hole 12 into the guide groove 11 and is threadedly connected to the guide block 10 to complete locking, so as to maintain a fixed state after adjusting the mounting position of the rear-view mirror by moving along the X-axis.

The guide groove 11 penetrates through the first straight section 5b of the connection seat 5. The guide block 10 on the connection block 7 extends toward the first straight section 5b of the connection seat 5. A length of the extended guide block 10 is greater than a length of the guide groove 11, to increase a moving distance of the guide block 10, and accordingly increase an adjustment range of the mounting position of the rear-view mirror along the X-axis.

The second movable bracket is a support plate 13, a side of the support plate 13 is provided with a fourth connection portion 13a, the fourth connection portion 13a is damping-rotatably connected to the third connection portion 5d on the connection seat 5 and rotates about the Z-axis, and the support plate 13 is provided with a second cooperation chamber at the fourth connection portion 13a. The rear-view mirror is mounted on the support plate 13 via a locking member, and is rotatable about the Y-axis when the locking member is unlocked. When the rear-view mirror is mounted on the support plate 13, a back surface of the rear-view mirror fits with one plate surface of the support plate 13, at this time, this plate surface is a mounting surface of the support plate 13, conversely, the other plate surface of the support plate 13 is a back surface. In the present embodiment, the locking member is a bolt. The support plate 13 is provided with a locking groove 14 on the back surface, an axis of the locking groove 14 is parallel to the Y-axis, a bottom of the locking groove 14 is provided with a through hole communicating with the mounting surface of the support plate 13. During installation, the bolt passes through the locking groove 14 and the through hole at the bottom of the locking groove 14 in sequence, and is threadedly connected to the rear-view mirror to complete locking, so as to maintain a fixed state after adjusting the mounting position of the rear-view mirror by rotating about the Y-axis, at this time, a head of the bolt is engaged in the locking groove 14. By loosening the bolt, the locking is released, and the rear-view mirror is configured to rotate about the Y-axis to adjust the mounting position, without the need to completely unscrew the bolt, so that the rear-view mirror is configured to remain connected to the support plate 13, facilitating reduction of disassembly and assembly during adjustment of the mounting position. In the present embodiment, the second movable bracket adopts the support plate 13, and according to actual needs, other structures of movable brackets may be employed instead.

In the present embodiment, both the first damping member 4 and the second damping member 8 are hemispherical damping blocks, and the hemispherical damping blocks have rough hemispherical surfaces. In the present embodiment, both the first cooperation chamber and the second cooperation chamber are concave cavities correspondingly cooperating with the hemispherical damping blocks, and the concave cavities have rough hemispherical cavity walls. The hemispherical surface of the hemispherical damping block contacts and rubs against the hemispherical cavity wall of the concave cavity to generate a damping force when the hemispherical damping block rotates in the concave cavity.

In the present embodiment, between the first connection portion 1b on the fixed plate 1 and the second connection portion 5c on the connection seat 5, and between the third connection portion 5d on the connection seat 5 and the fourth connection portion 13a on the support plate 13, are connected by bolts and nuts mutually threadedly cooperating to complete the connection.

The above embodiments of the present disclosure do not limit the protection scope of the present disclosure, the implementation methods of the present disclosure are not limited thereto, and various other modifications, substitutions, or changes made to the above structures of the present disclosure based on the above content of the present disclosure, according to ordinary technical knowledge and conventional means in the art, without departing from the basic technical idea of the present disclosure, shall fall within the protection scope of the present disclosure.

What is claimed is:

1. An off-road vehicle door rear-view mirror mounting bracket, comprising a fixed bracket configured to connect to a vehicle door, wherein the fixed bracket is provided with a first movable bracket rotatable about an X-axis, the first movable bracket is provided with a second movable bracket rotatable about a Z-axis, the second movable bracket is provided with a locking member configured to lock a rear-view mirror, and the rear-view mirror remains connected to the second movable bracket and is rotatable about a Y-axis when the locking member is released from locking.

2. The off-road vehicle door rear-view mirror mounting bracket according to claim 1, wherein the fixed bracket is formed with a door connection portion configured to connect to the vehicle door, and a first connection portion located on a side of the fixed bracket away from the door connection portion, and the first movable bracket is rotatably connected to the first connection portion about the X-axis.

3. The off-road vehicle door rear-view mirror mounting bracket according to claim 2, wherein the fixed bracket is provided with a connection column parallel to the X-axis at the first connection portion, the first movable bracket is rotatably connected to the connection column via a first damping member, and the connection column causes a gap to be formed between the first movable bracket and the fixed bracket.

4. The off-road vehicle door rear-view mirror mounting bracket according to claim 3, wherein the connection column is formed with a first cooperation chamber at an end away from the fixed bracket, the first movable bracket is rotatably connected to a connection end of the connection column, and causes the first damping member to be in rotational cooperation with the first cooperation chamber.

5. The off-road vehicle door rear-view mirror mounting bracket according to claim 4, wherein the first movable bracket is formed with a second connection portion rotatably connected to the connection column, and a third connection portion located on a side of the first movable bracket away from the second connection portion, and the second movable bracket is rotatably connected to the third connection portion about the Z-axis.

6. The off-road vehicle door rear-view mirror mounting bracket according to claim 5, wherein the first movable bracket is provided with a connection block movable along the X-axis, an end of the connection block extends out of the first movable bracket parallel to the fixed bracket, an extension end of the connection block serves as the third connection portion, and the second movable bracket is rotatably connected to the extension end of the connection block via a second damping member.

7. The off-road vehicle door rear-view mirror mounting bracket according to claim 6, wherein a bottom surface of the connection block is provided with a guide block, the first movable bracket is provided with a guide groove parallel to the X-axis, the guide block is slidably connected to the guide groove and slides along the guide groove; the first movable bracket is provided with an elongated hole communicating with the guide groove at a bottom portion, and a bolt passes through the elongated hole into the guide groove to lock the guide block.

8. The off-road vehicle door rear-view mirror mounting bracket according to claim 7, wherein a length of the guide block is greater than a length of the guide groove.

9. The off-road vehicle door rear-view mirror mounting bracket according to claim 6, wherein a side of the second movable bracket is provided with a fourth connection portion, the second movable bracket is provided with a second cooperation chamber at the fourth connection portion, the fourth connection portion is rotatably connected to the extension end of the connection block, and causes the second damping member to be in rotational cooperation with the second cooperation chamber.

10. The off-road vehicle door rear-view mirror mounting bracket according to claim 1, wherein the second movable bracket is provided with a mounting surface capable of fitting with a back surface of the rear-view mirror, the second movable bracket is provided with a locking groove with an axis parallel to a Y-axis on a back surface, a bottom of the locking groove is provided with a through hole communicating with the mounting surface of the second movable bracket, and the locking member passes through the locking groove and the through hole in sequence to lock the rear-view mirror.

11. The off-road vehicle door rear-view mirror mounting bracket according to claim 2, wherein the second movable bracket is provided with a mounting surface capable of fitting with a back surface of the rear-view mirror, the second movable bracket is provided with a locking groove with an axis parallel to a Y-axis on a back surface, a bottom of the locking groove is provided with a through hole communicating with the mounting surface of the second movable bracket, and the locking member passes through the locking groove and the through hole in sequence to lock the rear-view mirror.

12. The off-road vehicle door rear-view mirror mounting bracket according to claim 3, wherein the second movable bracket is provided with a mounting surface capable of fitting with a back surface of the rear-view mirror, the second movable bracket is provided with a locking groove with an axis parallel to a Y-axis on a back surface, a bottom of the locking groove is provided with a through hole communicating with the mounting surface of the second movable bracket, and the locking member passes through the locking groove and the through hole in sequence to lock the rear-view mirror.

13. The off-road vehicle door rear-view mirror mounting bracket according to claim 4, wherein the second movable bracket is provided with a mounting surface capable of fitting with a back surface of the rear-view mirror, the second movable bracket is provided with a locking groove with an axis parallel to a Y-axis on a back surface, a bottom of the locking groove is provided with a through hole communicating with the mounting surface of the second movable bracket, and the locking member passes through the locking groove and the through hole in sequence to lock the rear-view mirror.

14. The off-road vehicle door rear-view mirror mounting bracket according to claim 5, wherein the second movable bracket is provided with a mounting surface capable of fitting with a back surface of the rear-view mirror, the second movable bracket is provided with a locking groove with an axis parallel to a Y-axis on a back surface, a bottom of the locking groove is provided with a through hole communicating with the mounting surface of the second movable bracket, and the locking member passes through the locking groove and the through hole in sequence to lock the rear-view mirror.

15. The off-road vehicle door rear-view mirror mounting bracket according to claim 6, wherein the second movable bracket is provided with a mounting surface capable of fitting with a back surface of the rear-view mirror, the second movable bracket is provided with a locking groove with an axis parallel to a Y-axis on a back surface, a bottom of the locking groove is provided with a through hole communicating with the mounting surface of the second movable bracket, and the locking member passes through the locking groove and the through hole in sequence to lock the rear-view mirror.

16. The off-road vehicle door rear-view mirror mounting bracket according to claim 7, wherein the second movable bracket is provided with a mounting surface capable of fitting with a back surface of the rear-view mirror, the second movable bracket is provided with a locking groove with an axis parallel to a Y-axis on a back surface, a bottom of the locking groove is provided with a through hole communicating with the mounting surface of the second movable bracket, and the locking member passes through the locking groove and the through hole in sequence to lock the rear-view mirror.

17. The off-road vehicle door rear-view mirror mounting bracket according to claim 8, wherein the second movable bracket is provided with a mounting surface capable of fitting with a back surface of the rear-view mirror, the second movable bracket is provided with a locking groove with an axis parallel to a Y-axis on a back surface, a bottom of the locking groove is provided with a through hole communicating with the mounting surface of the second movable bracket, and the locking member passes through the locking groove and the through hole in sequence to lock the rear-view mirror.

18. The off-road vehicle door rear-view mirror mounting bracket according to claim 9, wherein the second movable bracket is provided with a mounting surface capable of fitting with a back surface of the rear-view mirror, the second movable bracket is provided with a locking groove with an axis parallel to a Y-axis on a back surface, a bottom of the locking groove is provided with a through hole communicating with the mounting surface of the second movable bracket, and the locking member passes through the locking groove and the through hole in sequence to lock the rear-view mirror.
